(19) United States
(12) Patent Application Publication
(10) Pub. No.: US 2020/0019920 A1
(43) Pub. Date: Jan. 16, 2020

(54) INTERFACE FOR AUTOMATED STORAGE AND RETRIEVAL SYSTEM

(71) Applicant: Walmart Apollo, LLC, Bentonville, AR (US)

(72) Inventors: Paul DURKEE, Centerton, AR (US); Bradley JOHNSON, Bentonville, AR (US)

(21) Appl. No.: 16/504,294

(22) Filed: Jul. 7, 2019

Related U.S. Application Data
(60) Provisional application No. 62/696,409, filed on Jul. 11, 2018.

(51) Int. Cl. G06Q 10/08

(52) U.S. Cl. CPC G06Q 10/087

(57) ABSTRACT

Systems and methods are disclosed for interfacing with an automated storage and retrieval system (ASRS) to identify a common customer profile for an incoming item, determine whether the incoming item is suitable for storage in an ASRS, determine whether a prior item has been staged, responsive to determining that a prior item has been staged, determine whether the prior item is located within an ASRS, responsive to determining that the prior item is not within an ASRS, issue an alert to a device that the prior item is not within an ASRS. Instructions may be issued to stage the incoming item with the prior item or set a flag for annotating retrieval instructions. Such an advantageous scheme may reduce customer waiting time and improve efficiency.

### CROSS-REFERENCE TO RELATED APPLICATION

This application claims the benefit of U.S. Provisional Application No. 62/696,409, filed Jul. 11, 2018, entitled “Interface for Automated Storage and Retrieval System”, the entirety of which is hereby incorporated by reference herein.

### BACKGROUND

When customers order multiple items that are delivered to a pick up location separately, the items may be staged at different times, by different people, in different locations. This may result in an unsatisfactory experience for the customer by increasing the wait time or requiring the customer to move to different areas to retrieve the multiple items.

### SUMMARY

Systems and methods are disclosed for interfacing with an automated storage and retrieval system (ASRS) to identify a common customer profile for an incoming item, determine whether the incoming item is suitable for storage in an ASRS, determine whether a prior item has been staged, responsive to determining that a prior item has been staged, determine whether the prior item is located within an ASRS, responsive to determining that the prior item is not within an ASRS, issue an alert to a device that the prior item is not within an ASRS. Instructions may be issued to stage the incoming item with the prior item or set a flag for annotating retrieval instructions. Such an advantageous scheme may reduce customer waiting time and improve efficiency.

Some embodiments of an interface for an ASRS, implemented on at least one processor, may comprise: a processor; and a non-transitory computer-readable medium storing instructions that are operative when executed by the processor to: identify a common customer profile for an incoming item; determine whether the incoming item is suitable for storage in an ASRS; determine whether a prior item has been staged; responsive to determining that a prior item has been staged, determine whether the prior item is located within an ASRS; responsive to determining that the prior item is not within an ASRS, issue an alert to a device that the prior item is not within an ASRS.

Some methods for interfacing with an ASRS, implemented on at least one processor, may comprise: identifying a common customer profile for an incoming item; determining whether the incoming item is suitable for storage in an ASRS; determining whether a prior item has been staged; responsive to determining that a prior item has been staged, determining whether the prior item is located within an ASRS; responsive to determining that the prior item is not within an ASRS, issuing an alert to a device that the prior item is not within an ASRS.

One or more exemplary computer storage devices having a first computer-executable instructions stored thereon for interfacing with an ASRS, which, on execution by a computer, cause the computer to perform operations which may comprise: identifying a common customer profile for an incoming item; determining whether the incoming item is suitable for storage in an ASRS; determining whether a prior item has been staged; responsive to determining that a prior item has been staged, determining whether the prior item is located within an ASRS; responsive to determining that the prior item is not within an ASRS, issuing an alert to a device that the prior item is not within an ASRS.

Alternatively, or in addition to the other examples described herein, examples include any combination of the following: issuing an alert to a device that the prior item is not within an ASRS comprises issuing instructions to stage the incoming item with the prior item; issuing an alert to a device that the prior item is not within an ASRS comprises setting a flag for annotating retrieval instructions; the instructions are further operative to: responsive to determining that the prior item is within an ASRS and to determining that the incoming item is suitable for storage in an ASRS, issue instructions that the incoming item is to be staged with the prior item in the same ASRS; the instructions are further operative to: responsive to determining that the prior item is within an ASRS and to determining that the incoming item is suitable for storage in an ASRS, determine whether there is sufficient room for the incoming item in the ASRS in which the prior item is staged; the instructions are further operative to: responsive to determining that there is insufficient room for the incoming item in the ASRS in which the prior item is staged, issue instructions that both the incoming item and the prior item are to be staged in a different ASRS; and the instructions are further operative to: responsive to determining that there is insufficient room for the incoming item in the ASRS in which the prior item is staged, set a flag for annotating retrieval instructions.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIGS. 1A and 1B illustrate an exemplary automated storage and retrieval system (ASRS).

FIG. 2 illustrates multiple staging locations for customer items awaiting retrieval.

FIG. 3 illustrates an employee device for receiving alerts and interfacing with an ASRS.

FIG. 4 illustrates a customer device displaying a barcode for interfacing with an ASRS.

FIGS. 5-7 are exemplary flow charts illustrating processes that may be used in conjunction with one or more ASRSs.

FIG. 8 is an exemplary block diagram illustrating an operating environment for a computing device that may be used with or within an ASRS.

Corresponding reference characters indicate corresponding parts throughout the drawings.

### DETAILED DESCRIPTION

A more detailed understanding may be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that may in isolation and out of context be read as absolute and therefore limiting, may only properly be read as being constructively preceded by a clause such as “In at least some embodiments, . . . .” For brevity and clarity of presentation, this implied leading clause is not repeated ad nauseum.

When customers order multiple items that are delivered to a pick up location separately, the items may be staged at different times, by different people, in different locations. Having orders staged in multiple locations can adversely impact customer wait-time and associates' labor efficiency. An associate may need to retrieve one order from a store room, and then meet the customer at another pickup point to retrieve and dispense the remaining parts of the order from an automated storage and retrieval system (ASRS). This may result in an unsatisfactory experience for the customer by increasing the wait time or requiring the customer to move to different areas to retrieve the multiple items. This problem can occur not only when the customer has a single order comprising multiple items, but may have multiple items that had been ordered separately, all awaiting retrieval.

However, when all items are in the same automated dispensing solution, the customer may often be able to retrieve a complete order, even when comprised of multiple items, without associate assistance. In this more advantageous scenario, the customer may be able to retrieve the multiple items of a completed order, and even items from multiple orders, in a single location and/or without associate assistance. Thus, instructing an associate who is staging an order for later retrieval by a customer of the existing bin locations for other customer items (that had been staged earlier, for example), may both save the customer time and also reduce or eliminate the need for a demand on the associate's time when the customer arrives.

Referring to the figures, examples of the disclosure instruct interfacing with an ASRS to identify a common customer profile for an incoming item, determine whether the incoming item is suitable for storage in an ASRS, determine whether a prior item has been staged, responsive to determining that a prior item has been staged, determine whether the prior item is located within an ASRS, responsive to determining that the prior item is not within an ASRS, issue an alert to a device that the prior item is not within an ASRS. Instructions may be issued to stage the incoming item with the prior item or set a flag for annotating retrieval instructions. Such an advantageous scheme may reduce customer waiting time and improve efficiency.

As an incoming item is staged, a service checks whether another item for the same customer (whether part of the same order or a different order) has already been staged (i.e., a “prior-staged item”). If so, a user interface (UI) either on an ASRS unit or an associate (or employee) device displays a message that there is already a staging location, possibly along with an identification of that location. Based on a set policy and storage option constraints, instructions may be given that the incoming item is to be staged with the prior-staged item, that the prior-staged item is to be moved to a common staging location as the incoming item, or else a flag will be set for annotating retrieval instructions regarding the disparate staging locations.

For example, in the event that two or more separate ASRS towers are used at the location, if a prior-staged item is in a first tower, an instruction may be issued to stage an incoming item to the same tower. Alternatively, if the first tower has insufficient storage capacity, an instruction may be issued to stage the incoming item in the second tower and then move the prior-staged item to the second tower. This may then save the customer time because both items may be retrieved from a single ASRS dispenser. As an example for three or more separate ASRS towers, if two prior-staged items are already separated in different towers, then staging of further incoming items may be limited to prevent spreading among more than two dispensers.

As yet another example, if a prior-staged item is in a location requiring retrieval by an associate (or store employee), such as a store room, an instruction may be issued to stage both items together. Items may be kept in an associate-retrieval location due to size constraints (too large to fit in an ASRS), age restrictions (such as spray paint), material restrictions (such as pool chemicals), and whether activation is required prior to use (such as gift cards or cellphones). For example, if a kayak is already in a back room when a life jacket arrives on a later date for an order associated with a same customer profile, and the life jacket could fit within an ASRS, the associate performing the staging of the life jacket may be instructed to store it with the kayak. Alternatively, the associate may be informed of the kayak and place the life jacked in an ASRS, and a flag may be set so that when the customer is alerted to pick up the items, the customer and associate are both informed about the separate storage locations.

In order to facilitate staging items from multiple different orders, the staging service may link items to both order numbers and a customer profile ID. In some embodiments, different customer IDs may also be linked, such as if the customers are of the same household or organization, and permission has been provided by each customer to allow the other to retrieve items. Advantages are applicable to storage scenarios involving one or more employee retrieval locations and/or one or more ASRS units.

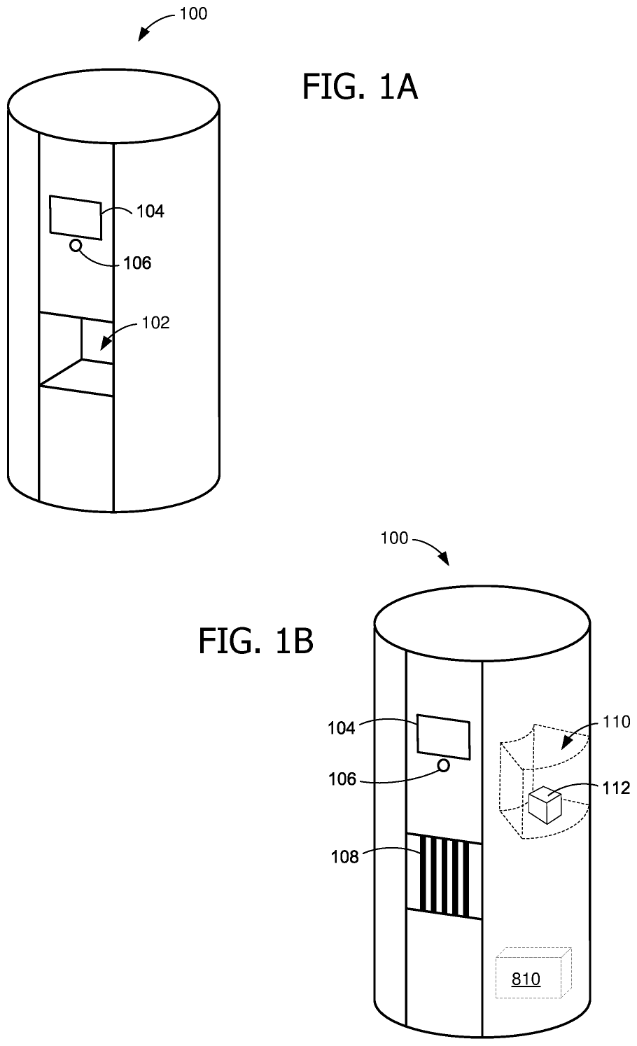

FIG. 1A illustrates an exemplary ASRS 100. In some embodiments, ASRS 100 may be referred to as a tower. ASRS 100 stores and then automatically dispenses customer items when the customer arrives to retrieve the items. ASRS 100 comprises a dispensing aperture 102, a user interface (UI) 104, and a sensor 106. Sensor 106 may operate as a scanner, for example, to read barcodes from customer devices. In some embodiments, sensor 106 may additionally have motion detection and other image capture capabilities. With such embodiments, when a customer approaches to retrieve an item, ASRS 100 may come out of a low-power state, and possibly collect an image of the customer during the transaction for security purposes, similarly to the way automated teller machines (ATMs) collect video images during transactions.

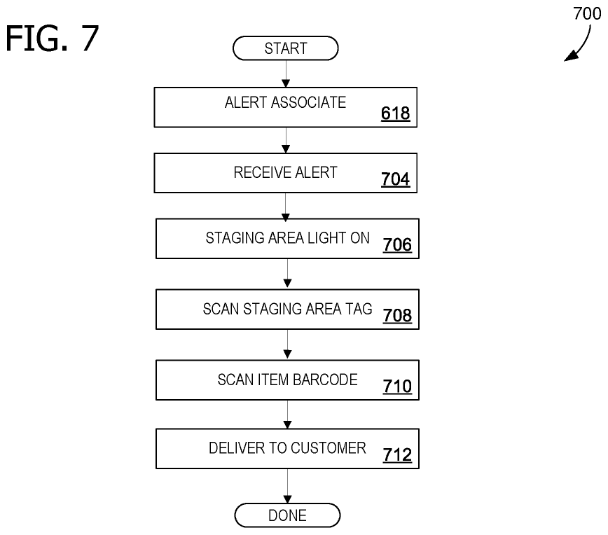

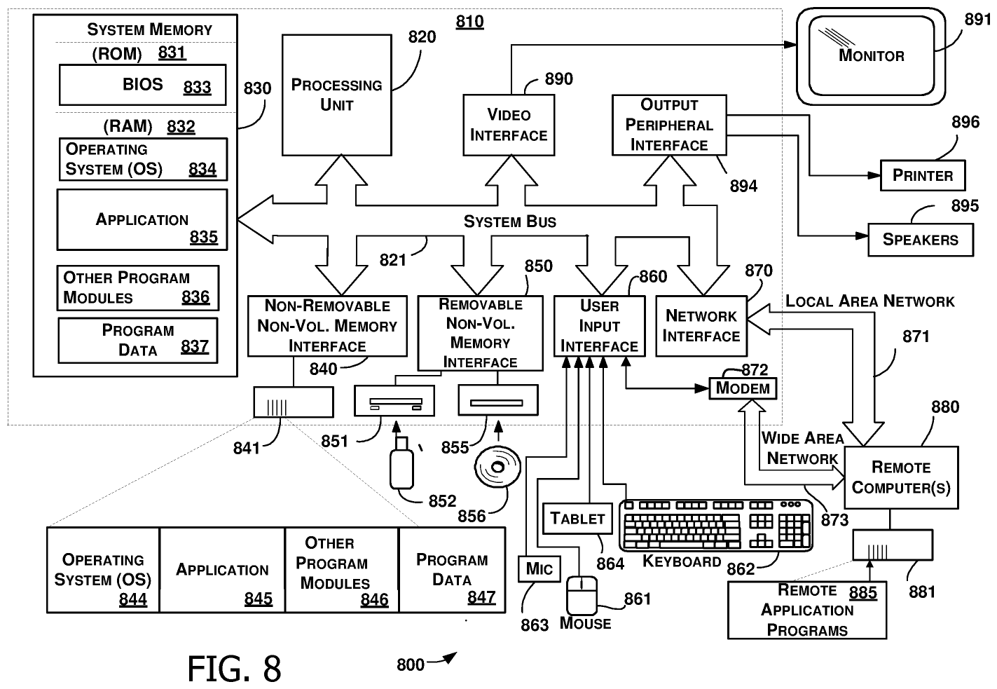

FIG. 1B provides another illustration of exemplary ASRS 100, although a door 108 is shown as closing off access to dispensing aperture 102. A shelf space 110 is occupied by a parcel 112, containing one or more customer items awaiting retrieval. In an exemplary operation, sensor 106 may scan a barcode on a customer device, and ASRS then identifies that the customer is attempting to retrieve parcel 112. An automated loader (not shown) within ASRS 100 will transport parcel 112 from shelf space 110 to dispensing aperture 102 and then open door 108. A computing node 810 is illustrated as being interior to ASRS 100, although it should be understood that computing and control functionality may be spread to being both internal and external to ASRS 100. Computing node 810 is able to handle both the operation of ASRS and sending alerts to customers and associates (store employees) that are described later, and provide both the logic and communication functionality for implementing the process flows illustrated in FIGS. 5-7. Computing node 810 will be described in more detail with regard to FIG. 8.

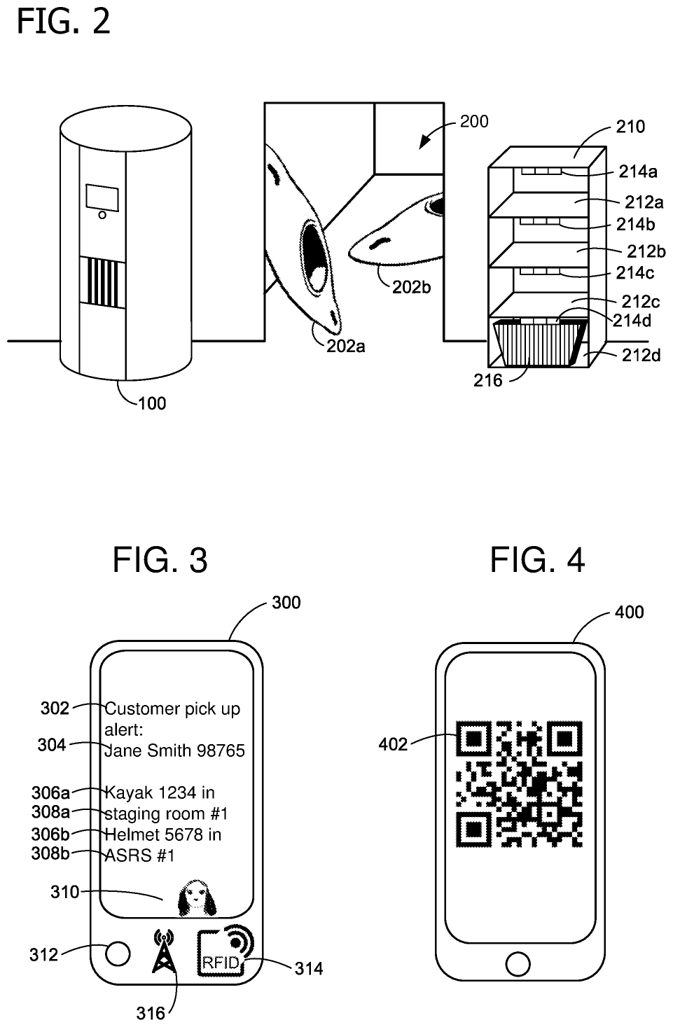

FIG. 2 illustrates multiple staging locations for customer items awaiting retrieval. In FIG. 2, three locations are illustrated: one ASRS 100, a store room 200 and a shelf unit 210. As illustrated, there are two items 202a and 202b that are too large to fit within ASRS 100. Items 202a and 202b are illustrated as kayaks. Shelf unit 210 is illustrated as having four shelf locations 212a-212d for storing items, although a larger or smaller number may be used, and in different arrangements. In some embodiments, shelf unit 210 may be implemented as a mobile cart having six bin locations, or some other number. In some embodiments, shelf unit 210 may be a secure, lockable container. As illustrated, shelf locations 212a-212d each has a corresponding ID/sensor unit 214a-214d, respectively. ID/sensor units 214a-214d provide multiple functionalities. For example, they may identify the specific shelf location with a human-readable label and also perhaps an RFID tag, as well as a light to draw an associate's attention to the specific shelf location, and a sensor to indicate when a bin, such as bin 216, has been pulled out. In an exemplary operation, when an associate is approaching shelf unit 210 to retrieve a customer item that had been staged in bin 216, a light on ID/sensor unit 214d will begin to blink, to draw the associate's attention. When the associate pulls bin 216 outward from shelf location 212d, ID/sensor unit 214d senses the motion and generates an indication that the staging location for the customer item has been accessed. Additionally, when staging an incoming item with a prior-staged item that is located within bin 216, a light on ID/sensor unit 214d may begin to blink to help the associate find shelf location 212d rapidly, and then a sensor on ID/sensor unit 214d identifies that bin 216 was accessed (pulled out).

Store room 200 and a shelf unit 210 are employee retrieval locations, whereas ASRS 100 is an automated retrieval location that may not require associate assistance. Certain items may not be suitable for ASRS 100, such as food items, large items, age restricted items, hazardous materials, and items requiring activation for proper use. In some embodiments, shelf locations 212a-212d may include weight sensors to detect depositing and removing items.

In one exemplary operation, shelf unit may be located within store room 200. A customer item, perhaps a helmet arrives first and is staged in ASRS 100. Later, another customer item from the same order, kayak 202a arrives; because it is too large to fit within ASRS 100, it is staged in store room 200. An alert is issued to an employee device move the helmet from ASRS 100 to shelf unit 210 so that both items may be retrieved from employee retrieval locations, rather than having the customer retrieve one item from ASRS and wait for an employee (associate) to retrieve the other. At a yet later time a life jacket, from a different order, but linked to the same customer profile ID, arrives. Although the life jacket could fit within ASRS 100, staging instructions issued to an employee device instruct the associate to stage the life jacket within shelf unit 210, so that it is with the customer's helmet. When the associate opens the bin containing the helmet, there is insufficient room for the life jacket. So the associate opens a different bin, scans the life jacket barcode, inserts the life jacket, and then uses an RFID link between shelf unit 210 and the employee device to record the storage location. When the customer arrives to retrieve the items and the retrieval service is alerted, the lights on both the bins (one holding the helmet and one holding the life jacket) begin to blink.

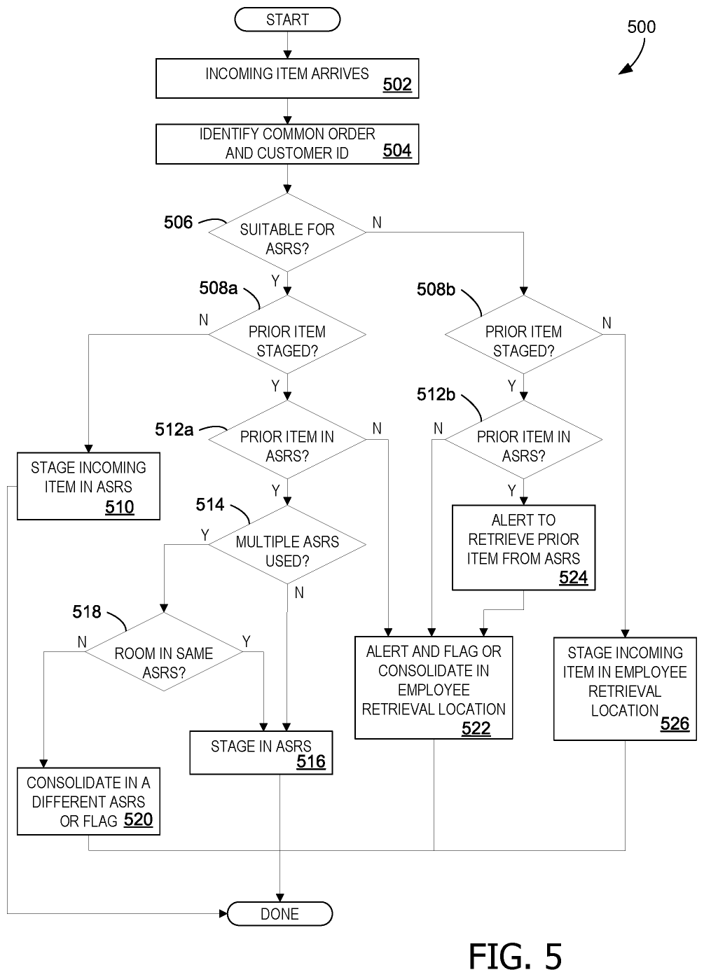

FIG. 3 illustrates an employee device 300, for receiving alerts, such as staging and retrieval instructions, and interfacing with one or more of ASRSs 100. Device 300 indicates an alert 302 for a customer pick up, a customer profile ID 304, items to be retrieved 306a and 306b, and locations 308a and 308b where the items may be located. As indicated, customer item 306b is within an ASRS, although this scenario depends on whether the implemented staging rules permit items to be split among ASRS and employee retrieval locations. A customer photo 310 can be used to verify the identity of the person retrieving the items, subject to proper privacy considerations and permissions. A sensor 312 may be used to collect photographs of items, for example when staging and retrieving for the customer, to furnish evidence of proper staging or hand-off. Sensor 312 may also scan item barcodes, although in some embodiments different sensors may collect photographic images and scan barcodes. An RFID sensor 314 may read RFID tags associated with a storage location, such as one of ID/sensor units 214a-214d of shelf unit 210 (see FIG. 2). Additionally, employee device 300 also includes a communication module 316 that represents one or more of a Bluetooth® communication module, Wi-Fi communication module, cellular communication module, or an infrared or other radio communication module for communicating with one or more of the internet, a private network, a wide area network (WAN), a local area network (LAN) or another type of network.

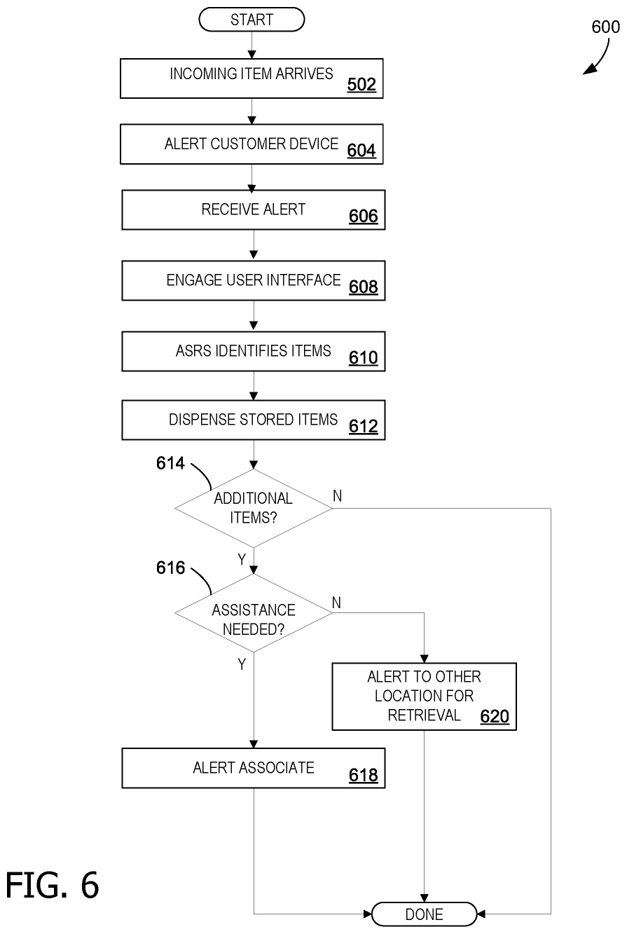

FIG. 4 illustrates a customer device 400 displaying a barcode 402 for interfacing with ASRS 100 (see FIG. 1). Customer device 400 may be the customer's own smartphone. In operation, after items have been staged, customer may receive an alert to come to the store to pick up the items, possibly as an email or Multimedia Messaging Service (MMS) or text message. The alert may include a map to the store, the service hours, an image of ASRS 100, a map of the location of ASRS 100 within the store facility, and barcode 402 for scanning by sensor 106 (see FIG. 1). Upon sensor 106 scanning barcode 402, ASRS 100 will dispense the customer's items. In the situation that the customer's items are split among two towers (two of ASRS 100) or an employee retrieval location, an alert to retrieve the items from the other location may be provided to the customer.

FIG. 5 is an exemplary flow chart illustrating a process 500 that may be used in conjunction with one or more ASRSs. An incoming customer item arrives 502. Multiple scenarios may have preceded this. The customer may have ordered from an e-commerce website and specified the delivery method as in-store pick-up, or the customer may have purchased the item earlier at the physical retail location, but it was not in stock at the time. In these situations, the item arrives via delivery, possibly on a truck. Alternatively, the customer may have purchased the item at a different retail location (which did not have the item in stock, but this retail location does), and so the item was pulled from stock rather than brought in from an external source. In other scenarios, the item is identified from an order and brought to a staging area for order completion. Any suitable scenario is contemplated by aspects of the disclosure herein where items arrive at a staging area for order completion.

The order includes an order number, which is associated with all the items in the same order. Additionally, the order may be associated with a customer ID profile, perhaps related to an e-commerce account. When a customer makes multiple orders with the same customer ID, although the order numbers may be different, the customer ID may be common across the plurality of orders made by that customer. In operation 504, the incoming customer item may thus be identified with an order and customer profile ID, and a check may be made whether another prior-arrived item (prior item), with a common order number and/or customer ID, has already been staged and is awaiting pick up by the same person. Decision operation 506 determines whether the incoming item is suitable for storage in an ASRS, or instead should be staged in an employee retrieval location, such as a store room or an employee-accessible shelf unit. (See FIG. 2.) Some of the reasons that an incoming item may not be suitable for storage in an ASRS include insufficient room in the ASRS and that the incoming item is not the type to be stored in an ASRS, such as food items, items requiring activation, age restricted items, and hazardous materials. If the incoming item is suitable for storage in an ASRS, and no prior items have been staged, as determined in decision operation 508a, then the incoming item is staged in an ASRS in operation 510.

If, however, it is determined in decision operation 508a that a prior item has been staged, decision operation 512a determines whether the prior item has been staged in an ASRS or else a different location, such as an employee retrieval location. If the prior item is in an ASRS, and there is only a single ASRS in operation, according to decision 514, then instructions are issued for the incoming item to be staged with the prior item in the common ASRS in operation 516. Had there been insufficient room in the single ASRS, then decision operation 506 may have signaled that the incoming item be staged elsewhere. In the case of multiple ASRSs, if there is sufficient room for the incoming item in the ASRS in which the prior item is staged, as determined in decision operation 518, then an instruction is issued (possibly to employee device 300 of FIG. 3) that the income item is to be staged (stored) in the same ASRS as the prior item. If, however, there is insufficient room in the ASRS in which the prior item is staged, as determined in decision operation 518, then an alert is issued (possibly to employee device 300 of FIG. 3) and also possibly instructions that both the incoming item and the prior item are to be staged in a different ASRS in operation 520. That is the prior item is moved to the ASRS where the incoming item is staged. Alternatively, the prior item may stay in its location and a flag is set, annotating retrieval instructions regarding the disparate staging locations, to be referenced later, such as by process flow 600 (of FIG. 6).

Revisiting decision operation 512a, if the prior item was not in an ASRS, perhaps because it was too large, or because it was staged with yet another prior item that was too large for an ASRS, then an alert is issued (possibly to employee device 300 of FIG. 3) that the prior item is not within an ASRS, in operation 522. Based on the rules and procedures, this alert may further include instructions to stage the incoming item with the prior item in an employee retrieval location in operation 522. Otherwise a flag is set, annotating retrieval instructions regarding the disparate staging locations, to be referenced later, such as by process flow 600 (of FIG. 6). Revisiting decision operation 506, if the incoming item is not suitable for an ASRS, and it is determined in decision operation 508b that a prior items is staged, then decision operation 512b determines whether the prior item is staged in an ASRS. If not, then the incoming item is staged along with the prior item (consolidated) in an employee retrieval location. If, however, the prior item is staged in an ASRS, then an alert is issued (possibly to employee device 300 of FIG. 3) to retrieve the prior item from the ASRS in operation 524, and both the prior item and the incoming item are staged in an employee retrieval location in operation 522. Revisiting decision operation 508b, if no prior item has been staged, the incoming item is staged in an employee retrieval location in operation 526.

FIG. 6 is an exemplary flow chart illustrating a process 600 that may be used in conjunction with one or more ASRSs. After operation 502, when an incoming customer item arrives 502 (see FIG. 5), an alert is issued to a customer, such as to a customer's device, in operation 604. The alert may be sent to a customer's cellular phone, for example. The customer's device receives the alert in operation 606, possibly containing a map to the store, a description of the items that have arrived, an image of an ASRS, instructions how to use the ASRS, a map of the ASRS location within the store facility, ad a barcode to have scanned by the ASRS to retrieve the items. The customer arrives at the store and engages the UI on the ASRS, such as UI 104 on ASRS 100 (of FIG. 1), in operation 608. The ASRS identifies the customer's items in operation 610, possibly by scanning the barcode on the customer's device, or else by the user typing in a code into the UI.

The ASRS then dispenses any internally stored items in operation 612, and determines, in decision operation 614, whether the customer has other items for retrieval that are not stored within the ASRS, such as within a different ASRS or in an employee retrieval location. If there are no other items to retrieve, the customer is done. Otherwise, if there are other items, decision operation 616 determines whether the customer will require the assistance of an associate (a store employee) to retrieve the items. This determination may use the flag set in operation 520 or 522 (of FIG. 5). If so, an alert is issued to an associate in operation 618, such as to employee device 300 (of FIG. 3). If, however, the other items are in another ASRS, the customer is informed in operation 620, possibly using the ASRS UI or another alert sent to the customer's device.

FIG. 7 is an exemplary flow chart illustrating a process 700 that may be used in conjunction with one or more ASRSs. Process 700 begins when an alert is sent in operation 618 of process 600 (see FIG. 6). An employee device receives the alert in operation 704, possibly using a wireless LAN, and if an item is staged in a location with an indicator, such as ID/sensor unit 214a-214d with lights that can blink to facilitate finding the exact location, the indicator is triggered in operation 706. In some embodiments, the associate scans the location RFID tag in operation 708, pulls out the bin, and scans the barcode on the item in operation 710, and delivers 712 the items to the customer.

### Exemplary Operating Environment

FIG. 8 is an exemplary block diagram illustrating an operating environment 800 for a computing device that may be used for controlling or interfacing with an ASRS. The computing system environment 800 is only one example of a suitable computing environment and is not intended to suggest any limitation as to the scope of use or functionality of the disclosure. Neither should the computing environment 800 be interpreted as having any dependency or requirement relating to any one or combination of components illustrated in the exemplary operating environment 800. The disclosure is operational with numerous other general purpose or special purpose computing system environments or configurations. Examples of well-known computing systems, environments, and/or configurations that may be suitable for use with the disclosure include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, and so forth, which perform particular tasks or implement particular abstract data types. The disclosure may also be practiced in distributed computing environments where tasks are performed by remote processing devices that are linked through a communications network. In a distributed computing environment, program modules may be located in local and/or remote computer storage media including memory storage devices and/or computer storage devices. As used herein, computer storage devices refer to hardware devices.

With reference to FIG. 8, an exemplary system for implementing various aspects of the disclosure may include a general purpose computing device in the form of a computing node (computer) 810. Components of the computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 810 typically includes a variety of computer-readable media. Computer-readable media may be any available media that may be accessed by the computer 810 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or the like. Memory 831 and 832 are examples of non-transitory computer-readable storage media. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by the computer 810. Computer storage media does not, however, include propagated signals. Rather, computer storage media excludes propagated signals. Any such computer storage media may be part of computer 810.

Communication media typically embodies computer-readable instructions, data structures, program modules or the like in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs, such as an application 835 that may perform operations described herein, other program modules 836 and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a universal serial bus (USB) port 851 that provides for reads from or writes to a removable, nonvolatile memory 852, and an optical disk drive 855 that reads from or writes to a removable, nonvolatile optical disk 856 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and USB port 851 and optical disk drive 855 are typically connected to the system bus 821 by a removable memory interface, such as interface 850.

The drives and their associated computer storage media, described above and illustrated in FIG. 8, provide storage of computer-readable instructions, data structures, program modules and other data for the computer 810. In FIG. 8, for example, hard disk drive 841 is illustrated as storing operating system 844, an application 845 that may perform operations described herein, other program modules 846 and program data 847. Note that these components may either be the same as or different from operating system 834, optimization environment 835, other program modules 836, and program data 837. Operating system 844, optimization environment 845, other program modules 846, and program data 847 are given different numbers herein to illustrate that, at a minimum, they are different copies. A user may enter commands and information into the computer 810 through input devices such as a tablet, or electronic digitizer, 864, a microphone 863, a keyboard 862 and pointing device 861, commonly referred to as mouse, trackball or touch pad. Other input devices not shown in FIG. 8 may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. The monitor 891 may also be integrated with a touch-screen panel or the like. Note that the monitor and/or touch screen panel may be physically coupled to a housing in which the computing device 810 is incorporated, such as in a tablet-type personal computer. In addition, computers such as the computing device 810 may also include other peripheral output devices such as speakers 895 and printer 896, which may be connected through an output peripheral interface 894 or the like.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include one or more local area networks (LAN) 871 and one or more wide area networks (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860 or other appropriate mechanism. A wireless networking component such as comprising an interface and antenna may be coupled through a suitable device such as an access point or peer computer to a WAN or LAN. In a networked environment, program modules depicted relative to the computer 810, or portions thereof, may be stored in the remote memory storage device. By way of example, and not limitation, FIG. 8 illustrates remote application programs 885 as residing on memory device 881. It may be appreciated that the network connections shown are exemplary and other means of establishing a communications link between the computers may be used.

### Exemplary Operating Methods and Systems

An exemplary interface for an ASRS, implemented on at least one processor, comprises: a processor; and a non-transitory computer-readable medium storing instructions that are operative when executed by the processor to: identify a common customer profile for an incoming item; determine whether the incoming item is suitable for storage in an ASRS; determine whether a prior item has been staged; responsive to determining that a prior item has been staged, determine whether the prior item is located within an ASRS; responsive to determining that the prior item is not within an ASRS, issue an alert to a device that the prior item is not within an ASRS.

An exemplary method for interfacing with an ASRS, implemented on at least one processor, comprises: identifying a common customer profile for an incoming item; determining whether the incoming item is suitable for storage in an ASRS; determining whether a prior item has been staged; responsive to determining that a prior item has been staged, determining whether the prior item is located within an ASRS; responsive to determining that the prior item is not within an ASRS, issuing an alert to a device that the prior item is not within an ASRS.

One or more exemplary computer storage devices having a first computer-executable instructions stored thereon for interfacing with ASRS, which, on execution by a computer, cause the computer to perform operations which comprise: identifying a common customer profile for an incoming item; determining whether the incoming item is suitable for storage in an ASRS; determining whether a prior item has been staged; responsive to determining that a prior item has been staged, determining whether the prior item is located within an ASRS; responsive to determining that the prior item is not within an ASRS, issuing an alert to a device that the prior item is not within an ASRS.

An interface for an ASRS, implemented on at least one processor, may comprise: a processor; and a non-transitory computer-readable medium storing instructions that are operative when executed by the processor, the instructions comprising logic for implementing any of the methods or processes disclosed herein.

Alternatively, or in addition to the other examples described herein, examples include any combination of the following:
issuing an alert to a device that the prior item is not within an ASRS comprises issuing instructions to stage the incoming item with the prior item;
issuing an alert to a device that the prior item is not within an ASRS comprises setting a flag for annotating retrieval instructions;
the instructions are further operative to: responsive to determining that the prior item is within an ASRS and to determining that the incoming item is suitable for storage in an ASRS, issue instructions that the incoming item is to be staged with the prior item in the same ASRS;
the instructions are further operative to: responsive to determining that the prior item is within an ASRS and to determining that the incoming item is suitable for storage in an ASRS, determine whether there is sufficient room for the incoming item in the ASRS in which the prior item is staged;
the instructions are further operative to: responsive to determining that there is insufficient room for the incoming item in the ASRS in which the prior item is staged, issue instructions that both the incoming item and the prior item are to be staged in a different ASRS; and
the instructions are further operative to: responsive to determining that there is insufficient room for the incoming item in the ASRS in which the prior item is staged, set a flag for annotating retrieval instructions.

The examples illustrated and described herein as well as examples not specifically described herein but within the scope of aspects of the disclosure constitute an exemplary entity-specific value optimization environment. The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. An interface for an automated storage and retrieval system (ASRS), implemented on at least one processor, the interface comprising:
a processor; and
a non-transitory computer-readable medium storing instructions that are operative when executed by the processor to:
identify a common customer profile for an incoming item;
determine whether the incoming item is suitable for storage in an ASRS;
determine whether a prior item has been staged;
responsive to determining that a prior item has been staged, determine whether the prior item is located within an ASRS;
responsive to determining that the prior item is not within an ASRS, issue an alert to a device that the prior item is not within an ASRS.

2. The system of claim 1 wherein issuing an alert to a device that the prior item is not within an ASRS comprises issuing instructions to stage the incoming item with the prior item.

3. The system of claim 1 wherein issuing an alert to a device that the prior item is not within an ASRS comprises setting a flag for annotating retrieval instructions.

4. The system of claim 1 wherein the instructions are further operative to:
responsive to determining that the prior item is within an ASRS and to determining that the incoming item is suitable for storage in an ASRS, issue instructions that the incoming item is to be staged with the prior item in the same ASRS.

5. The system of claim 1 wherein the instructions are further operative to:
responsive to determining that the prior item is within an ASRS and to determining that the incoming item is suitable for storage in an ASRS, determine whether there is sufficient room for the incoming item in the ASRS in which the prior item is staged.

6. The system of claim 5 wherein the instructions are further operative to:
responsive to determining that there is insufficient room for the incoming item in the ASRS in which the prior item is staged, issue instructions that both the incoming item and the prior item are to be staged in a different ASRS.

7. The system of claim 5 wherein the instructions are further operative to:
responsive to determining that there is insufficient room for the incoming item in the ASRS in which the prior item is staged, set a flag for annotating retrieval instructions.

8. A method for interfacing with an automated storage and retrieval system (ASRS), implemented on at least one processor, the method comprising:
identifying a common customer profile for an incoming item;
determining whether the incoming item is suitable for storage in an ASRS;
determining whether a prior item has been staged;
responsive to determining that a prior item has been staged, determining whether the prior item is located within an ASRS;
responsive to determining that the prior item is not within an ASRS, issuing an alert to a device that the prior item is not within an ASRS.

9. The method of claim 8 wherein issuing an alert to a device that the prior item is not within an ASRS comprises issuing instructions to stage the incoming item with the prior item.

10. The method of claim 8 wherein issuing an alert to a device that the prior item is not within an ASRS comprises setting a flag for annotating retrieval instructions.

11. The method of claim 8 further comprising:
responsive to determining that the prior item is within an ASRS and to determining that the incoming item is suitable for storage in an ASRS, issuing instructions that the incoming item is to be staged with the prior item in the same ASRS.

12. The method of claim 8 further comprising:
responsive to determining that the prior item is within an ASRS and to determining that the incoming item is suitable for storage in an ASRS, determining whether there is sufficient room for the incoming item in the ASRS in which the prior item is staged.

13. The method of claim 12 further comprising:
responsive to determining that there is insufficient room for the incoming item in the ASRS in which the prior item is staged, issuing instructions that both the incoming item and the prior item are to be staged in a different ASRS.

14. The method of claim 13 further comprising:
responsive to determining that there is insufficient room for the incoming item in the ASRS in which the prior item is staged, setting a flag for annotating retrieval instructions.

15. One or more computer storage devices having a first computer-executable instructions stored thereon for interfacing with an automated storage and retrieval system (ASRS), which, on execution by a computer, cause the computer to perform operations comprising:
identifying a common customer profile for an incoming item;
determining whether the incoming item is suitable for storage in an ASRS;
determining whether a prior item has been staged;
responsive to determining that a prior item has been staged, determining whether the prior item is located within an ASRS;
responsive to determining that the prior item is not within an ASRS, issuing an alert to a device that the prior item is not within an ASRS.

16. The one or more computer storage devices of claim 15 wherein issuing an alert to a device that the prior item is not within an ASRS comprises issuing instructions to stage the incoming item with the prior item.

17. The one or more computer storage devices of claim 15 wherein issuing an alert to a device that the prior item is not within an ASRS comprises setting a flag for annotating retrieval instructions.

18. The one or more computer storage devices of claim 15 wherein the operations further comprise:
responsive to determining that the prior item is within an ASRS and to determining that the incoming item is suitable for storage in an ASRS, issuing instructions that the incoming item is to be staged with the prior item in the same ASRS.

19. The one or more computer storage devices of claim 15 wherein the operations further comprise:
responsive to determining that the prior item is within an ASRS and to determining that the incoming item is suitable for storage in an ASRS, determining whether there is sufficient room for the incoming item in the ASRS in which the prior item is staged; and
responsive to determining that there is insufficient room for the incoming item in the ASRS in which the prior item is staged, issuing instructions that both the incoming item and the prior item are to be staged in a different ASRS.

20. The one or more computer storage devices of claim 15 wherein the operations further comprise:
responsive to determining that the prior item is within an ASRS and to determining that the incoming item is suitable for storage in an ASRS, determining whether there is sufficient room for the incoming item in the ASRS in which the prior item is staged; and
responsive to determining that there is insufficient room for the incoming item in the ASRS in which the prior item is staged, setting a flag for annotating retrieval instructions.
